(19) United States
(12) Patent Application Publication
(10) Pub. No.: US 2013/0220377 A1
(43) Pub. Date: Aug. 29, 2013

(54) METHOD OF CLEANING A FILM-FORMING APPARATUS

(71) Applicant: L'Air Liquide Societe Anonyme Pour L'Etude et L'Exploitation des Procedes Georges Claude, (US)

(72) Inventors: Yuusuke SATO, Tokyo (JP); Naoki TAMAOKI, Tokyo (JP); Satoko SETA, Inagi (JP); Regis ZILS, Thionville (FR); Jun SONOBE, Tsukuba (JP); Takako KIMURA, Urayasu (JP); Kayo MOMODA, Tsukuba (JP)

(73) Assignee: L'Air Liquide Societe Anonyme Pour L'Etude et L'Exploitation des Procedes Georges Claude, Paris (FR)

(21) Appl. No.: 13/843,941

(22) Filed: Mar. 15, 2013

Related U.S. Application Data
(63) Continuation of application No. 10/927,097, filed on Aug. 27, 2004.

(30) Foreign Application Priority Data
Aug. 29, 2003 (JP) 2003209691

(51) Int. Cl. B08B 7/04

(52) U.S. Cl. CPC B08B 7/04
USPC 134/19

(57) ABSTRACT

A method of cleaning a film-forming apparatus to remove at least a part of a silicon-based material deposited on a constituent member of the film-forming apparatus after used to form thin films includes introducing a first-gas including fluorine gas and a second gas including nitrogen monoxide gas into the film-forming apparatus, and heating the constituent member. The constituent member includes quartz or silicon carbide, and the silicon-based material includes silicon nitride.

### CROSS-REFERENCE TO RELATED APPLICATIONS

This application is a continuation application of pending application Ser. No. 10/927,097 filed Aug. 27, 2004, which the benefit of priority under 35 USC 119(e) from prior Japanese Patent Application No. 2003-209691, filed Aug. 29, 2003, the entire contents of each being incorporated herein by reference.

### BACKGROUND OF THE INVENTION

1. Field of the Invention

This invention relates to a method for the cleaning of film-forming apparatuses and to a film-forming apparatus that is equipped with a cleaning system.

2. Description of the Related Art

The production of semiconductor devices includes the formation of various (insulating) thin films, such as silicon dioxide films and silicon nitride films, on a semiconductor wafer using a film-forming apparatus provided with a chemical vapor deposition reaction chamber (CVD reaction chamber). During this thin-film formation process, CVD reaction products are deposited not only on the semiconductor wafer target, but also on constituent members of the film-forming apparatus, e.g., the inner walls of the CVD reaction chamber, the boat or susceptor that carries or supports the semiconductor wafer, and the interior of conduits. When this deposited CVD reaction product is not removed, it can exfoliate from, inter alia, the inner walls of the CVD reaction chamber, causing the generation of particles and thereby impairing the quality of the semiconductor thin films formed on the semiconductor wafer in the ensuing CVD reactions. Cleaning of the film-forming apparatus is therefore required.

For example, low pressure (LP) CVD equipment is typically cleaned by opening the equipment to the atmosphere and cleaning with an acidic solution. Since this requires that the film-forming apparatus first be stopped and then disassembled, cleaned, reassembled, and leak-checked, this process is time-consuming and also very hazardous and thus is problematic in terms of productivity and process safety.

Also commercially available is LPCVD equipment that uses a reactive plasma to carry out cleaning without having to open up the film-forming apparatus. The reaction gas used here is, for example, NF₃, CF₄, etc. Within the context of reducing the use of particular fluorocarbons, cleaning technology has also been disclosed (WO 02/257131) that employs FNO gas or F₃NO as the plasma-generating gas; this cleaning technology removes silicon-containing compounds deposited on stainless steel or aluminum or alloy thereof. However, these plasma-based cleaning technologies entail the installation of an expensive plasma device just for cleaning, although this is not integral to the CVD functionality itself. In addition, because the active chemical species generated by the plasmas are typically highly corrosive and also short lived, the interior walls of the equipment must frequently be subjected to special treatment, which creates problems with regard to equipment cost.

Cleaning the interior the CVD reaction chamber by a thermal reaction using reactive gas has also been proposed for LPCVD equipment. A single fluorine-containing gas, e.g., ClF₃, NF₃, HF or fluorine gas, or a mixture of these gases, is used as the reactive gas. One problem with cleaning using these reactive gases is the substantial damage to the quartz typically used as the furnace wall material of CVD reaction chambers. When these reactive gases are used, and particularly when the removal of silicon nitride is being pursued, an etching rate is typically obtained that is just the same as for the quartz making up the furnace walls. This causes a major reduction in the service life of equipment components with corresponding high maintenance costs.

In order to address these problems, Japanese Patent Disclosure (Kokai) No. 2000-77391 discloses technology for cleaning off silicon nitride by a thermal reaction that uses ClF₃ to which nitrogen monoxide gas has been added. One problem here is the high cost of cleaning, caused by the fact that ClF₃ is an expensive gas.

### BRIEF SUMMARY OF THE INVENTION

A problem addressed by this invention, therefore, is the provision of a method for cleaning film-forming apparatuses that can remove silicon-type deposits from the interior components of a film-forming apparatus using a thermal reaction and that can do so without requiring a plasma device and with minimal damage to the constituent members of the film-forming apparatus. Another problem addressed by this invention is the provision of a film-forming apparatus that implements said cleaning method.

As the result of extensive investigations directed to solving the aforementioned problems, the inventors discovered that silicon nitride deposits could be selectively and rapidly cleaned from quartz and silicon carbide members by the use as cleaning gas of fluorine gas to which nitrogen monoxide gas been added. This invention is based on this knowledge.

With respect to the cleaning of a film-forming apparatus in order to remove silicon-type deposits occurring on a constituent member of the film-forming apparatus after use of the film-forming apparatus to produce a thin film, a first aspect of this invention provides a method for cleaning film-forming apparatuses, characterized by introducing into the film-forming apparatus a first gas comprising fluorine gas and a second gas comprising nitrogen monoxide gas and heating the constituent member, wherein the constituent member is composed of quartz or silicon carbide and the silicon-type deposit comprises silicon nitride.

A second aspect of this invention provides a film-forming apparatus that can form a film on a wafer within a reaction chamber and that is characteristically provided with a first gas introduction means that introduces a first gas comprising fluorine gas into the aforesaid reaction chamber and a second gas introduction means that introduces a second gas comprising nitrogen monoxide into the aforesaid reaction chamber.

### BRIEF DESCRIPTION OF THE SEVERAL VIEWS OF THE DRAWING

FIG. 1 is a block diagram illustrating a film-forming apparatus equipped with a cleaning system according to an embodiment of the invention;

FIG. 2 is a block diagram illustrating a film-forming apparatus equipped with a cleaning system according to another embodiment of the invention;

FIG. 3 is a block diagram illustrating a film-forming apparatus equipped with a cleaning system according to still another embodiment of the invention;

FIG. 4 is a graph showing etching selectivity of silicon nitride to quartz relative to a cleaning temperature;

FIG. 5 is a graph showing etching rate and selectivity of silicon nitride and quartz relative to the flow ratio of nitrogen monoxide gas flow rate and fluorine gas flow rate;

FIG. 6 is a graph showing etching rates of silicon nitride and quartz relative to the flow ratio of nitrogen monoxide gas flow rate and fluorine gas flow rate; and

FIG. 7 is a graph showing etching selectivity of silicon nitride to quartz relative to the flow ratio of nitrogen monoxide gas flow rate and fluorine gas flow rate.

### DETAILED DESCRIPTION OF THE INVENTION

Embodiments of this invention are described in greater detail hereinbelow.

In a first embodiment, this invention relates to a cleaning method in which cleaning gas is introduced into a film-forming apparatus in order to remove silicon-type deposits occurring on the constituent members of the film-forming apparatus, and uses cleaning gas comprising a mixed gas of a first gas comprising fluorine (F₂) gas and a second gas comprising nitrogen monoxide (NO) gas.

When removal of silicon-type deposits from the internal components of the film-forming apparatus is to be carried out using this first embodiment, the film-forming apparatus is typically first evacuated in order to exhaust its interior once the process of producing the silicon-type film has been completed.

The film-forming apparatus comprises, for example, a CVD reaction chamber and lines (conduits) for introducing and exhausting the CVD precursor gas. A mounting member is also disposed within the film-forming apparatus; this mounting member supports or carries the semiconductor wafer that is the target of the particular film production process. This mounting member is, for example, a boat when the apparatus carries out batch film formation and a susceptor when the apparatus carries out single-wafer film formation. The constituent members of the film-forming apparatus include the CVD reaction chamber, the conduits attached to the CVD reaction chamber, and the semiconductor wafer mounting member. The walls of the CVD reaction chamber are typically composed of quartz in the case of a batch film-forming apparatus and are typically composed of quartz or stainless steel in the case of a single-wafer film-forming apparatus. The semiconductor wafer mounting member is in both cases typically composed of quartz, silicon carbide (SiC), or a carbon material whose surface has been coated with silicon carbide. The conduits are typically composed of quartz or stainless steel. Silicon oxide films and silicon nitride films are the silicon-type thin films whose production is carried out by the film-forming apparatus. This invention cleans off the silicon nitride deposited on the quartz members and silicon carbide members.

The constituent members of the film-forming apparatus are heated after the film-forming apparatus has been exhausted. In the case of batch-type film-forming apparatuses, the CVD reaction chamber is heated by a heater disposed on the circumference of the CVD reaction chamber. The semiconductor wafer mounting boat disposed within the CVD reaction chamber is also heated at this time. In the case of single-wafer film-forming apparatuses, the susceptor is heated by a heater disposed within the susceptor. The CVD reaction chamber can also be heated in the case of single-wafer film-forming apparatuses by a heater disposed on the circumference of the CVD reaction chamber.

Once the constituent members of the film-forming apparatus have been heated, a first gas comprising fluorine gas and a second gas comprising nitrogen monoxide gas are admitted into the CVD reaction chamber. An inert diluent gas can also be admitted at this time as the occasion demands. This inert diluent gas can be, for example, nitrogen or a rare gas such as argon.

The interior of the CVD reaction chamber can be maintained under a pressure from 0.1 torr to 760 torr during cleaning with the first gas (fluorine gas) and the second gas (nitrogen monoxide gas).

Based on a consideration of etching selectivity for silicon-type deposits versus the constituent members of the film-forming apparatus, introduction into the CVD reaction chamber during cleaning is carried out at a flow rate ratio of the second gas (nitrogen monoxide gas) to the first gas (fluorine gas), i.e., the second gas/first gas flow rate ratio, generally in the range from 0.01 to less than 2. When this second gas/first gas flow rate ratio is 2 or more, the selectivity is reduced and the etching rate for silicon-type deposits is also substantially slowed. More specifically, by setting the second gas/first gas flow rate ratio R in the range 0.01≦R<2, the etching rate for silicon-type deposits is substantially increased and the etching rate selectivity ratio with respect to the constituent members of the film-forming apparatus is also improved.

This cleaning can generally be carried out at temperatures from room temperature to 1000° C. However, high temperatures above 400° C. and low temperatures below 100° C. result in smaller differences between the etching rate for the constituent members and the etching rate for the silicon-type deposits that are the target of the cleaning process. Cleaning is therefore preferably carried out at 100° C. to 400° C. Carrying out cleaning at 100° C. to 400° C. enables the maximum etching rate selectivity ratio to be obtained at the second gas/first gas flow rate ratio that has been established for the particular cleaning operation. The cleaning temperature is preferably around 200° C. Since a high etching rate for silicon-type deposits by the first and second gases occurs at temperatures above 400° C., cleaning can also be carried out first at a temperature above 400° C. to the vicinity of the interface with the constituent member of the film-forming apparatus, the temperature can then be lowered continuously or stepwise, and cleaning can thereafter be completed at 100° C. to 400° C. (preferably around 200° C.) where the etching rate selectivity ratio is higher. Preliminary measurement of the thickness of the silicon-type deposits and the etching rate of the silicon-type deposits by the cleaning gas enables cleaning to the silicon-type deposit/constituent member interface to be controlled through the cleaning time.

As is clear from the preceding description, the silicon-type deposits can be rapidly cleaned with minimal damage to the constituent members of the film-forming apparatus by using a cleaning temperature in the range of 100° C. to 400° C. and establishing the second gas/first gas flow rate ratio R in the range 0.01≦R<2.

The second gas increases the etching rate for the silicon-type deposits while having little effect on the constituent members of the film-forming apparatus, which enables the silicon-type deposits to be selectively cleaned off while restraining damage to the constituent members of the film-forming apparatus to a minimum.

The fluorine gas (first gas) can be synthesized onsite and can be introduced into the CVD reaction chamber either directly or after the synthesized fluorine gas has been temporarily stored. Since fluorine gas cannot be filled into cylinders at high pressures for safety reasons, the use of a cylinder-based feed to support long-term cleaning or cleaning of a plurality of film-forming apparatuses in parallel is quite difficult. This difficulty can be circumvented by synthesis of the fluorine gas onsite. Means for the electrolysis of HF can be used to synthesize the fluorine gas. The use of a system that produces fluorine gas onsite by HF electrolysis and that feeds this fluorine gas to the CVD reaction chamber enables long-term cleaning—or cleaning of a plurality of devices in parallel—to be carried out free of the limitations imposed by a cylinder supply source. Equipment for producing fluorine gas by HF electrolysis is available commercially.

Cleaning need not be carried out after each silicon-type thin film production cycle. Cleaning is typically carried out after some number of film production cycles once the thickness of the silicon-type deposit on the constituent members, e.g., the interior walls of the CVD reaction chamber, has reached an impermissible value.

Meanwhile, as described above, pipes of the film-forming apparatus may be formed of a stainless steel. It has been found that the life of a stainless steel pipe whose inner surface is coated with nickel, aluminum or alumina is longer, compared to a stainless steel pipe without any coat when it is exposed to fluorine gas nitrogen monoxide gas simultaneously (particularly, an evacuation pipe). The prolonged service life can also be obtained if such a pipe itself is formed of nickel or aluminum. Stainless steel exhibits a particular behavior that its reactivity with a mixture of fluorine gas and nitrogen monoxide gas is higher than that with fluorine gas alone or a mixture of fluorine gas and hydrogen fluoride gas.

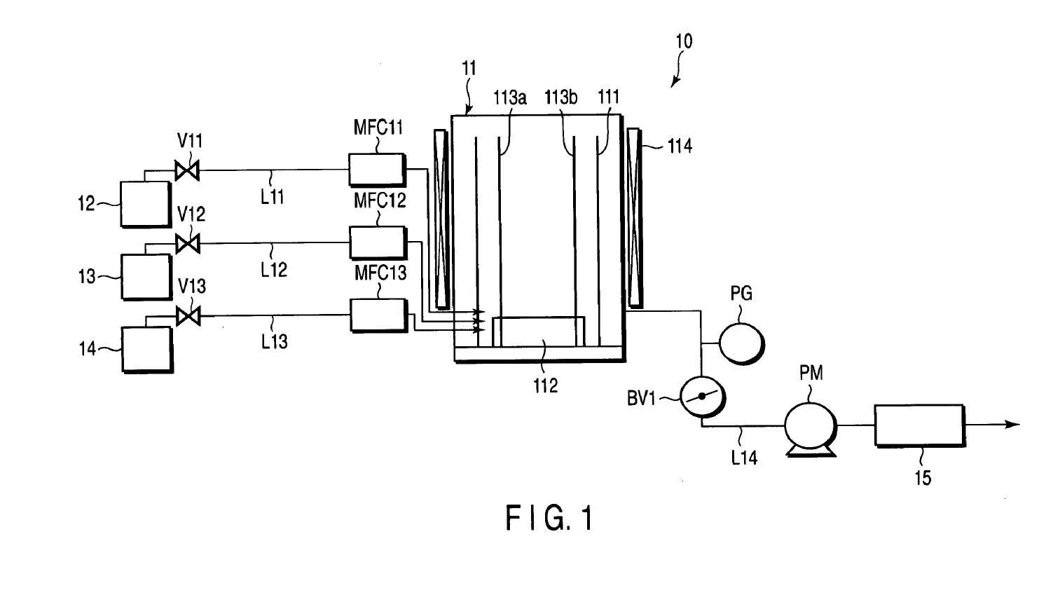

FIG. 1 contains a block diagram that illustrates an example of a film-forming apparatus that is provided with a cleaning system according to the first embodiment of this invention. This film-forming apparatus engages in separate introduction of the first and second gases into the CVD reaction chamber.

The film-forming apparatus 10 illustrated in FIG. 1 is provided with a CVD reaction chamber 11, a first gas (fluorine gas) feed source 12, a second gas (nitrogen monoxide gas) feed source 13, and an inert diluent gas feed source 14 that operates as required.

The CVD reaction chamber 11 comprises, for example, a quartz reaction furnace, whose interior is provided with, for example, a quartz process tube 111. Disposed within this process tube 111 are, for example, a semiconductor substrate support platform 112 made of stainless steel and a pair of quartz rods 113a, 113b that are provided with a plurality of grooves that can hold inserted semiconductor substrates (not shown). This pair of quartz rods 113a, 113b constitutes a so-called boat. A heater 114 is disposed on the circumference of the CVD reaction chamber 11. The semiconductor substrates are removed from the boat (113a, 113b) once production of the silicon-type thin film has been completed. The CVD reaction chamber 11 can be heated to a prescribed temperature by the heater 114.

The fluorine gas (first gas) is introduced from its feed source 12 (for example, a cylinder) into the CVD reaction chamber 11 through the fluorine gas feed line L11. The line L11 is provided with a switching valve V11 and with a flow rate controller, for example, a mass flow controller MFC11, downstream from this valve. The fluorine gas is adjusted to the prescribed flow rate by the mass flow controller MFC11 and is then introduced into the CVD reaction chamber 11.

The second gas (nitrogen monoxide gas) is introduced from its feed source 13 (for example, a cylinder) into the CVD reaction chamber 11 through the second gas feed line L12. The line L12 is provided with a switching valve V12 and with a flow rate controller, for example, a mass flow controller MFC12, downstream from this valve. The second gas is adjusted to the prescribed flow rate by the mass flow controller MFC12 and is then introduced into the CVD reaction chamber 11.

Inert diluent gas is introduced as necessary through the inert diluent gas feed line L13 from its feed source 14 (for example, a cylinder) into the CVD reaction chamber 11. The line L13 is provided with a switching valve V13 and with a flow rate controller, for example, a mass flow controller MFC13, downstream from this valve. The inert diluents gas is adjusted to the prescribed flow rate by the mass flow controller MFC13 and is then introduced into the CVD reaction chamber 11.

The outlet from the CVD reaction chamber 11 is connected by the line L14 to a waste gas treatment apparatus 15. This waste gas treatment apparatus 15 removes the byproducts and unreacted substances, and the gas cleaned by the waste gas treatment apparatus 15 is discharged to the outside. A pressure sensor PG, pressure controller, for example, a butterfly valve BV1, and a vacuum pump PM are connected to the line L14. The pressure in the CVD reaction chamber 11 is established at the prescribed value by monitoring with the pressure sensor PG and aperture control of the butterfly valve BV1.

In order to carry out the usual CVD reactions (production of silicon-type thin film), a CVD precursor gas feed system (not shown) is also connected to the CVD reaction chamber 11.

After, for example, the formation of a silicon nitride film on the semiconductor substrate in the apparatus in FIG. 1, the silicon nitride deposits on the interior walls of the CVD reaction chamber 11, the inner and outer surfaces of the process tube 111, the quartz rods 113a, 113b, etc., can be cleaned off using the inventive method.

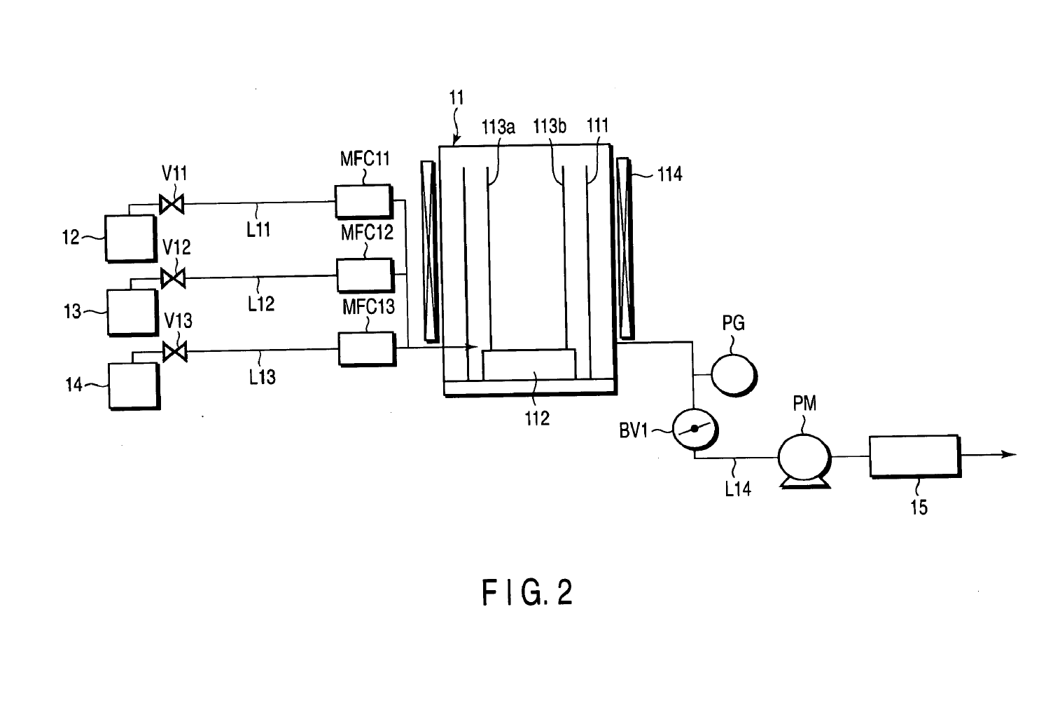

FIG. 2 illustrates the introduction of the first and second gases into the CVD reaction chamber after the gases have been preliminarily mixed. The film-forming apparatus in this case has the same structure as in FIG. 1. Those structural features in FIG. 2 in common with the film-forming apparatus of FIG. 1 have been assigned the same reference symbols and will not be described in detail again.

In the film-forming apparatus illustrated in FIG. 2, the second gas feed line L12 flows into the first gas feed line L11 upstream from the semiconductor chamber 11 and this combined line flows into the inert diluent gas feed line L13. This configuration enables the first gas, second gas, and inert diluent gas to be introduced into the CVD reaction chamber 11 after these gases have been mixed with each other.

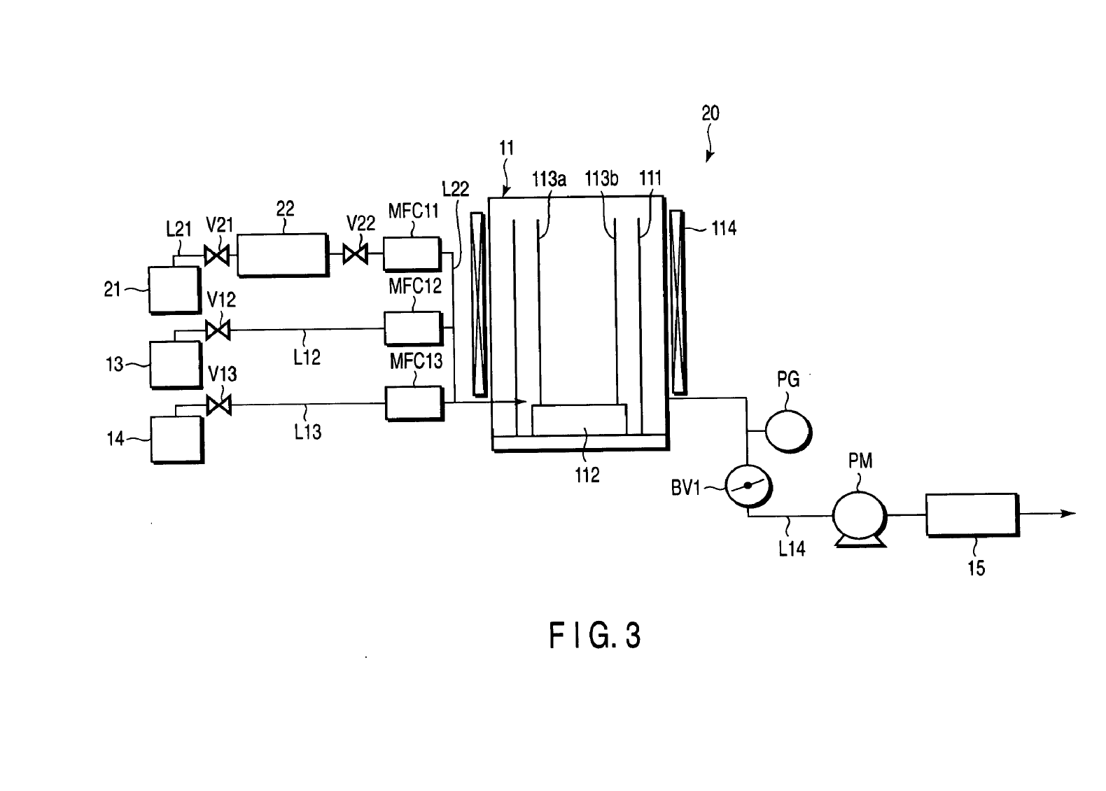

FIG. 3 illustrates a film-forming apparatus 20 that is provided with an onsite fluorine gas production system, but whose structure is otherwise the same as the film-forming apparatus 10 illustrated in FIG. 2.

In place of the fluorine gas feed source 12 in the film-forming apparatus in FIG. 2, the film-forming apparatus 20 illustrated in FIG. 3 is provided with a hydrogen fluoride (HF) gas feed source 21 and a fluorine gas production apparatus 22 that produces fluorine gas by the electrolysis of HF. HF gas passes from its feed source 21 through the HF gas feed line L21 and is introduced into the fluorine gas production apparatus 22. A switching valve V21 is disposed in the HF gas feed line L21. A buffer tank (not shown) may be provided downstream from the fluorine gas production apparatus 22 in order to temporarily store the produced fluorine gas. The produced fluorine gas passes through the fluorine gas feed line L22 and is introduced into the CVD reaction chamber 11 in combination with the second gas and optionally the inert diluent gas. A switching valve V22 and, downstream therefrom, a flow controller, e.g., mass flow controller MFC11, are provided in the line L22. The fluorine gas is introduced into the CVD reaction chamber 11 controlled to the specified flow rate by the mass flow controller MFC11.

FIG. 3 illustrates a system in which the fluorine gas and second gas are introduced into the CVD reaction chamber after the gases have been mixed with each other, but the fluorine gas and second gas may be introduced into the CVD reaction chamber separately, as in the apparatus shown in FIG. 1.

Batch-type film-forming apparatuses are illustrated in the FIGS. 1-3 described hereinabove, but as also noted above this invention can of course also be applied to single-wafer film-forming apparatuses.

Silicon nitride deposits on quartz members or on silicon carbide can thus be selectively cleaned off through application of this invention as described above.

This invention is not limited to the embodiments provided hereinabove and at the stage of actual implementation can be given form by altering the constituent elements within a range that does not overstep the essence of this invention. Moreover, various embodiments of this invention can be derived by suitable combination of the plural number of constituent elements disclosed in the preceding embodiments. For example, some constituent elements may be omitted from the overall set of constituent elements illustrated in an embodiment. In addition, constituent elements from different embodiments can be combined.

### EXAMPLES

This invention is described hereinbelow by examples, but is not limited to these examples.

### Example 1

Fluorine gas and nitrogen monoxide gas were introduced into a CVD reaction chamber that contained a quartz sample and a sample on which silicon nitride had been deposited and cleaning was carried out under the following conditions.

Fluorine gas flow rate: 500 sccm

Nitrogen monoxide gas flow rate: 200 sccm

Nitrogen flow rate: 300 sccm

Pressure in the CVD reaction chamber: 50 Torr

Cleaning temperature: 200° C.

The results were an etching rate for silicon nitride of 3500 angstroms/minute and an etching rate for quartz of 220 angstroms/minute. The selectivity ratio for the silicon nitride film etching rate versus the quartz etching rate in this example was about 16, which demonstrated that selective silicon nitride cleaning was achieved.

### Example 2

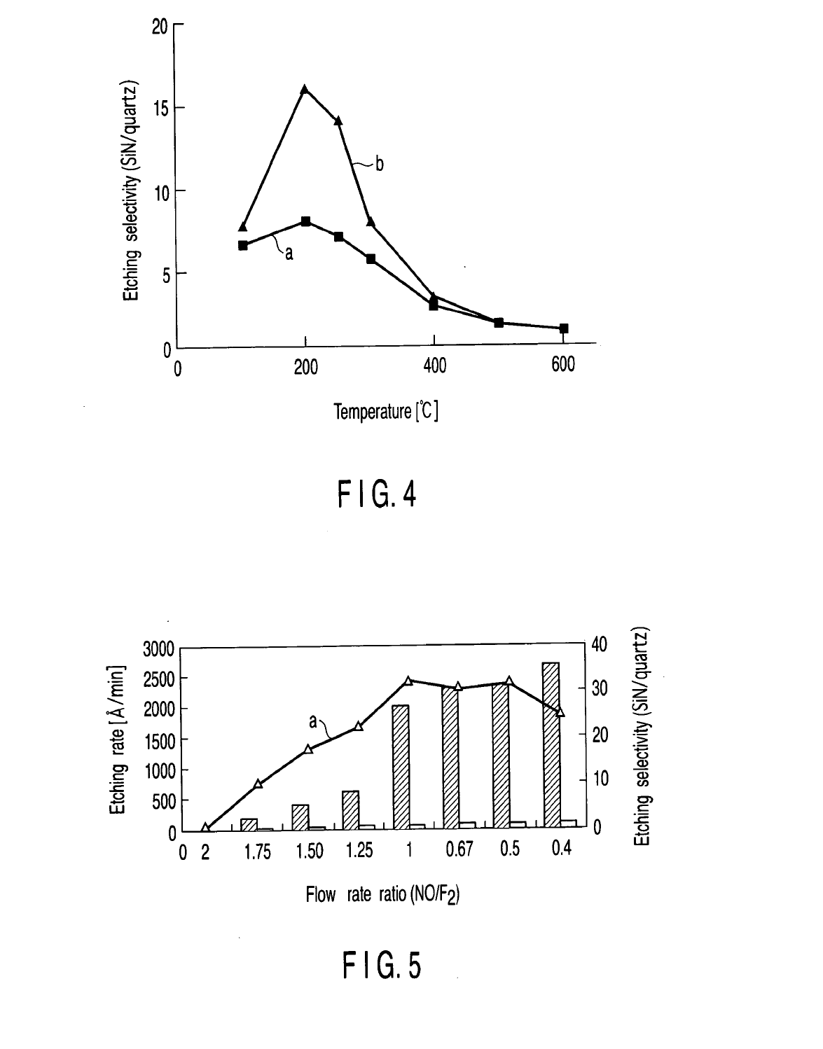

Fluorine gas and nitrogen monoxide gas were introduced into a CVD reaction chamber that contained a quartz sample and a sample on which silicon nitride had been deposited and cleaning was carried out at a pressure within the CVD reaction chamber of 50 torr, a fluorine gas flow rate of 500 sccm, and a total gas flow rate of 1000 sccm. The cleaning temperature in this case was varied in the range from 100° C. to 600° C. The nitrogen monoxide gas flow rate was also varied from 100 sccm to 200 sccm. Nitrogen was used to make up the difference from the total gas flow rate of 1000 sccm. The results are reported in FIG. 4. Line a in FIG. 4 respectively reports the results for an NO/F₂ flow rate ratio of 0.2.

The results in FIG. 4 demonstrate that a maximum etching rate selectivity ratio (silicon nitride (denoted as SiN in FIG. 4)/quartz) is obtained at each NO/F₂ flow rate ratio within the cleaning temperature range from 100° C. to 400° C.

### Example 3

Fluorine gas and nitrogen monoxide gas were introduced into a CVD reaction chamber that contained a quartz sample and a sample on which silicon nitride had been deposited and cleaning was carried out at a pressure within the CVD reaction chamber of 50 torr, a cleaning temperature of 200° C., a nitrogen monoxide gas flow rate of 200 sccm, and a total gas flow rate of 1000 sccm. The fluorine gas flow rate was varied in the range from 100 sccm to 500 sccm. Nitrogen was used to make up the difference from the total gas flow rate of 1000 sccm. The results are reported in FIG. 5. The hatched bar graph in FIG. 5 reports the silicon nitride etching rate; the open bar graph reports the quartz etching rate; and line a reports the etching selectivity ratio (silicon nitride/quartz).

The results in FIG. 5 show that the etching rate and etching selectivity ratio both decline as the nitrogen monoxide gas/fluorine gas flow rate ratio approaches 2. It was thus shown that the nitrogen monoxide gas/fluorine gas flow rate ratio must be less than 2 in order to clean silicon nitride deposits more rapidly than a quartz member.

### Example 4

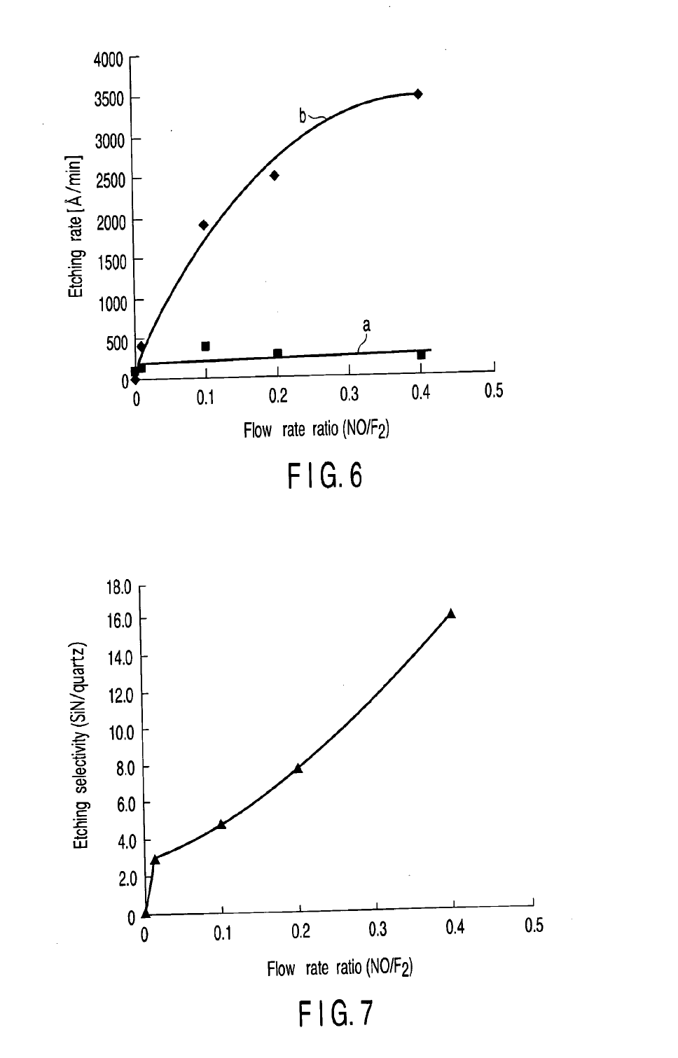

Fluorine gas and nitrogen monoxide gas were introduced into a CVD reaction chamber that contained a quartz sample and a sample on which silicon nitride had been deposited and cleaning was carried out at a pressure within the CVD reaction chamber of 50 torr, a cleaning temperature of 200° C., and a fluorine gas flow rate of 500 sccm. The nitrogen monoxide gas flow rate was varied in the range from 0 sccm to 200 sccm. In order to maintain a total gas flow rate of 1000 sccm, nitrogen was used to make up the difference therefrom. The etching rate results are reported in FIG. 6. FIG. 7 reports the results for the selectivity ratio of the silicon nitride etching rate relative to quartz. Line a in FIG. 6 reports the results for quartz and line b reports the results for silicon nitride.

The results reported in FIG. 6 show that the addition of nitrogen monoxide gas enables the silicon nitride etching rate alone to be selectively raised while the quartz etching rate is maintained constant. The results reported in FIG. 6 also show that the silicon nitride etching rate exhibits a tendency to become saturated as the addition of nitrogen monoxide gas increases and that an effect is seen at a nitrogen monoxide gas/fluorine gas flow rate ratio of not smaller than 0.01. The results reported in FIG. 7 show that the etching rate for silicon nitride (denoted as SiN in FIG. 7) is larger than the etching rate for quartz at a nitrogen monoxide gas/fluorine gas flow rate ratio of not smaller than 0.01.

### Example 5

Fluorine gas, second gas (nitrogen monoxide gas), and nitrogen were supplied at a flow rate ratio of 50/1/49 into a CVD reaction chamber loaded with a silicon carbide sample, a sample on which silicon oxide had been deposited, and a sample on which silicon nitride had been deposited. The etching rates for the individual samples were measured at 300° C. while maintaining the pressure within the reaction chamber at 50 torr. The following results were obtained.

silicon carbide etching rate: 50 Å/min

silicon oxide etching rate: 90 Å/min

silicon nitride etching rate: 380 Å/min

For comparison, the second gas (nitrogen monoxide gas) was not introduced while the etching rates of the individual samples were measured at 300° C. while maintaining the pressure in the reaction chamber at 50 torr and introducing the fluorine gas and nitrogen at a flow rate ratio of 50/50. The results are reported below.

silicon carbide etching rate: 6 Å/min

silicon oxide etching rate: 14 Å/min

silicon nitride etching rate: 0 Å/min

These results show that the use of fluorine gas and nitrogen monoxide gas as the cleaning gas enable silicon nitride deposited on a constituent member comprising silicon carbide or silicon oxide (quartz) to be cleaned off at high selectivity ratios.

### Example 6

A stainless steel SS-316L test piece and a nickel test piece were exposed at 200° C. to a mixture of fluorine gas and hydrogen fluoride gas (F₂/HF volume ratio=50/50) or to a mixture of fluorine gas and nitrogen monoxide gas (F₂/NO volume ratio=50/50), at 760 Torr for specified time. The penetration depth of fluorine from the surface of the test piece after the exposure was measured by the Auger electron spectroscopy. The reaction rate (mm/year) of each test piece by each of the gaseous mixtures was calculated from the penetration depth and the exposure time. The results are shown Table 1 below.

TABLE 1

Reaction rate (mm/year)
by the gas mixture

| Gas mixture | SS-316L | Ni |
|---|---|---|
| F₂ + HF | 0.018 | — |
| F₂ + NO | 0.055 | 0.01 |

Table 1 clearly indicates that the stainless steel is more reactive with a mixture of fluorine gas and nitrogen monoxide gas than with a mixture of fluorine gas and hydrogen fluoride gas. On the other hand, nickel is scarcely reactive with a mixture of fluorine gas and nitrogen monoxide gas.

As described hereinabove, the inventive method enables the rapid, high-speed cleaning of silicon-type deposits without inflicting damage on the constituent members of the film forming apparatus. In particular, the use of a cleaning temperature in the range from 100° C. to 400° C. enables the maximum selectivity ratio to be obtained at the specific flow rate conditions established in a particular instance. In addition, the second gas/first gas flow rate ratio exercises a significant effect on the selectivity ratio and the etching rate, and the use of a flow rate ratio in the range from 0.01 to less than 2 in particular enables silicon-type deposits to be cleaned off at high speeds and high selectivity ratios.

Additional advantages and modifications will readily occur to those skilled in the art. Therefore, the invention in its broader aspect is not limited to the specific details and representative embodiments shown and described herein. Accordingly, various modifications may be made without departing from the spirit or scope of the general inventive concept as defined by the appended claims and their equivalents.

We claim:

1. A method of cleaning a film-forming apparatus to remove at least a part of a silicon-based material deposited on a constituent member of the film-forming apparatus after used to form thin films, comprising introducing a cleaning gas consisting of a first gas comprising fluorine gas and a second gas comprising nitrogen monoxide gas into the film-forming apparatus; and heating the constituent member, wherein the constituent member comprises quartz or silicon carbide, and the silicon-based material comprises silicon nitride, wherein the constituent member is heated to 100° C. to 400° C.

2. The method according to claim 1, wherein the first gas is supplied from a hydrogen fluoride electrolysis device equipped to the film-forming apparatus.

3. The method according to claim 1, wherein the cleaning is carried out such that after the silicon-based material is removed to reach an area near an interface with the constituent member while heating the constituent member to a temperature higher than 400° C., the temperature is lowered, and the cleaning is finished at a temperature of 100° C. to 400° C.

4. The method according to claim 1, wherein a flow ratio of the first gas introduced into the film-forming apparatus to the second gas is set at 0.01 or more, but smaller than 2.

5. The method according to claim 1, wherein the film-forming apparatus comprises a stainless steel pipe whose inner surface of the pipe is coated with nickel, aluminum or alumina.

6. The method according to claim 1, wherein the film-forming apparatus comprises a nickel or aluminum pipe.
